(19) United States
(12) Patent Application Publication
(10) Pub. No.: US 2025/0342685 A1
(43) Pub. Date: Nov. 6, 2025

(54) IMAGE RECOGNITION METHOD, ELECTRONIC DEVICE, AND COMPUTER-READABLE STORAGE MEDIUM

(71) Applicant: Shenzhen Reolink Technology Co., Ltd., Shenzhen (CN)

(72) Inventors: Hao Gan, Shenzhen (CN); Qingjie Chen, Shenzhen (CN); Yanchong Chai, Shenzhen (CN)

(21) Appl. No.: 19/270,737

(22) Filed: Jul. 16, 2025

(30) Foreign Application Priority Data
Jul. 18, 2024 (CN) 202410971422.7

(51) Int. Cl. G06V 10/80; G06V 10/46

(52) U.S. Cl. CPC G06V 10/803; G06V 10/467; G06T 2207/20081

(57) ABSTRACT

This application relates to an image recognition method, an electronic device, and a non-transitory computer-readable storage medium. In the image recognition method, an image to be recognized is inputted into an image recognition model, and the image recognition model includes an encoder and a detection head. The image to be recognized is processed by the encoder to obtain a plurality of target fusion feature maps with different scales, and the target fusion feature map is recognized by the detection head to obtain an image recognition result of the image to be recognized. The image recognition method can accurately recognize one or more target objects from an image via the image recognition model.

### TECHNICAL FIELD

This application relates to the technical field of image processing, and particularly relates to an image recognition method, an electronic device and a non-transitory computer-readable storage medium.

### BACKGROUND

With the development of electronic technology, the image recognition is widely used in various industries, such as detecting target objects from surveillance videos, recognizing and classifying targets in images, etc. In order to improve the efficiency of image recognition, an image can be recognized by an image recognition model to obtain an image recognition result. It will be appreciated that, before using an image to identify a model, it is usually necessary to construct an initial model and to train the initial model, and the trained model can be used to identify an image after the training is completed. The higher the accuracy of the trained model is, the higher the accuracy of the image recognition result obtained by image recognition by the model is.

The technique of using Marked Auto-Encoder (MAE) training method on a convolution network is mainly the next generation convolution network version 2. The technique adopts a full convolution network structure, which results in a complex convolution network structure of an encoder and is not conducive to the deployment of edge-end devices. In addition, the fine-grained features are not paid enough attention by the non-editing network. The decoder also fails to solve the long-distance dependence relationship between global features and local features, which ultimately leads to low accuracy of the decoder. Therefore, there is a lack of an image recognition model that can recognize the target objects from the images more accurately.

### SUMMARY

In view of the above-mentioned problems, this application provides an image recognition method, an electronic device and a non-transitory computer-readable storage medium for solving the problems existing in the prior art that there is a lack of an image recognition model that can recognize target objects from images more accurately.

In one aspect, the present application provides an image recognition method. The image recognition method includes inputting an image to be recognized into an image recognition model including an encoder and a detection head; processing the image to be recognized by the encoder to obtain a plurality of target fusion feature maps with different scales; and recognizing the target fusion feature map by the detection head to obtain an image recognition result of the image to be recognized.

In an optional manner, the encoder includes a first convolution layer, a plurality of second convolution layers connected in cascade, a first feature fusion layer and a second feature fusion layer. The first convolution layer is connected to the second convolution layer, and the second convolution layer is connected to the first feature fusion layer. The first fusion layer is connected to the second fusion layer, and the second feature fusion layer is connected to the decoder, wherein the convolution kernel size and the step size of the first convolution layer are the same.

In an optional manner, the encoder is trained by performing operations including: constructing an encoder to be trained; constructing a decoder and a loss function calculation module, wherein the second feature fusion layer is connected to the decoder; dividing the training image set into different groups of batch training images; inputting one of the grouped batch training images into the encoder; acquiring an encoded feature map and inputting the encoded feature map into the decoder to obtain a first prediction image; calculating a loss value by the loss function calculation module based on the batch training image and the first prediction image; calculating a gradient of the loss value to each parameter of the encoder by using a back-propagation algorithm, and updating the parameters of the encoder according to the gradient; inputting batch training images of the remaining groups into the encoder in batches to update the parameters of the encoder until one round of training of the encoder is completed by the training image set; and saving the updated parameters as weights of the encoder when the number of training rounds reaches a preset threshold value.

In an optional manner, the encoded feature map is output from the encoder by performing operations including: performing convolution processing on the batch training images via the first convolution layer to obtain a first feature map; performing mask processing on the first feature map by a first mask image corresponding to the batch training images to obtain a second feature map; performing convolution processing on the second feature map in sequence via a plurality of the second convolution layers to obtain a plurality of third feature maps of different scales; performing feature fusion processing on the plurality of third feature maps via the first feature fusion layer to obtain a plurality of first fusion feature maps of different scales; performing feature fusion processing on the plurality of first fusion feature maps via the second feature fusion layer to obtain a second fusion feature map; and adding a mask mark to a masked position in the second fusion feature map to obtain the encoded feature map.

In an optional manner, the second feature map is obtained by performing the following operations: constructing a first mask image corresponding thereto for the batch training images, wherein the first mask image has the same scale as the first feature map, and the pixel value of some pixel points in the first mask image is 0, and the pixel value of the remaining pixel points is 1; and performing bitwise multiplication processing on the first feature map and the first mask image to obtain the second feature map.

In an alternative manner, pixel values of a*T pixel points in the first mask image are 0, and the pixel values of the remaining pixel points are 1, wherein T is the total number of pixel points in the first mask image, 60%≤a≤75%, and the symbol “*” represents a multiplication sign.

In an alternative manner, the encoder is further trained by performing operations including: constructing a mask mark image, wherein the mask mark image and the second fusion feature map have the same scale; and performing OR operation processing on the second fusion feature map and the mask mark image to obtain the encoded feature map.

In an alternative manner, the first prediction image is obtained by performing operations including: performing stretching processing on the encoded feature map to obtain the encoded feature map represented by a one-dimensional vector; and inputting the encoded feature map represented by the one-dimensional vector into the decoder to obtain the first prediction image, wherein the decoder is a Transformer decoder.

In an alternative manner, the first feature map includes a plurality of feature image blocks; the inputting the encoded feature map into the decoder to obtain a first prediction image includes inputting the encoded feature map into the decoder to obtain a plurality of prediction image blocks output by the decoder, wherein the plurality of feature image blocks correspond to the plurality of prediction image blocks one by one; and performing inverse blocking processing on the plurality of prediction image blocks to obtain the first prediction image.

In an alternative manner, the encoder is further trained by performing operations including: performing scaling processing on the first mask image to obtain a second mask image, wherein the scale of the second mask image is the same as that of the first prediction image; performing inverse processing on pixel values of various pixel points in the second mask image to obtain a third mask image; performing bitwise multiplication processing on the first prediction image and the third mask image to obtain a second prediction image; and inputting the batch training image and the second prediction image into the loss function calculation module to obtain a loss value output by the loss function calculation module.

In an alternative manner, the first feature map includes a plurality of feature image blocks; the first mask image includes a plurality of mask image blocks; and the plurality of feature image blocks and the plurality of mask image blocks are the same in number and have one-to-one correspondence in position.

In a second aspect, the present application further provides an electronic device including a memory, at least one processor and a computer program stored on the memory, wherein the at least one processor executes the computer program to implement the image recognition method as described above.

In a third aspect, the present application further provides a computer-readable storage medium having stored thereon a computer program which, when executed by one or more processors, implements the image recognition method as described above.

In present application, since the encoder can fuse feature information of different scales, and the fused large-scale feature map can capture more local and more detailed features, which is suitable for detecting fine-grained features and enhances the robustness of the encoder features, so that the training accuracy of the image recognition model is improved, and then the image can be accurately recognized by using the image recognition model including the trained encoder and the detection head.

### BRIEF DESCRIPTION OF THE DRAWINGS

The drawings are only for purposes of illustrating the embodiments and are not to be construed as limiting the application. Moreover, like reference numerals designate like parts throughout the drawings. In the drawings,

FIG. 1 shows a schematic diagram of an application scenario according to an embodiment of the present application;

FIG. 2 shows a flow diagram of a training method for an encoder according to an embodiment of the present application;

FIG. 3 shows a structurally schematic diagram of an encoder according to an embodiment of the present application;

FIG. 4 shows a flow diagram of steps performed by the encoder in training the encoder according to an embodiment of the present application;

FIG. 5 shows a schematic diagram of a feature map at various stages in the training of the encoder according to an embodiment of the present application;

FIG. 6 shows a structurally schematic diagram of a Transformer decoder according to an embodiment of the present application;

FIG. 7 shows a schematic diagram of pixel values of each pixel point in a first mask image and a second mask image according to an embodiment of the present application;

FIG. 8A and FIG. 8B show schematic diagrams of a training image and a corresponding second prediction image according to an embodiment of the present application;

FIG. 9 shows a flow diagram of an image recognition method according to an embodiment of the present application; and

FIG. 10 shows a structurally schematic diagram of an electronic device according to an embodiment of the present application.

### DETAILED DESCRIPTION

Hereinafter, exemplary embodiments of the present application will be described in more detail with reference to the accompanying drawings. Although illustrative embodiments of the present application are shown in the accompanying drawings, it should be understood that the application may be embodied in various forms and should not be construed as limited to the embodiments set forth herein.

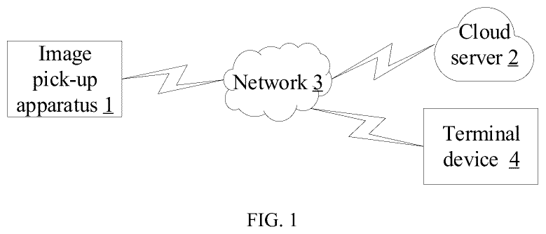

FIG. 1 shows a schematic diagram of an application scenario according to an embodiment of the present application. As shown in FIG. 1, an image pick-up apparatus 1 establishes a communication connection with a cloud server 2 via a network 3, and a terminal device 4 establishes a communication connection with the cloud server 2 via the network 3. The image pick-up apparatus 1 can be a camera for security monitoring, a networked camera or other video monitoring equipment. The network 3 includes but is not limited to one or more of Local Area Network (LAN), Metropolitan Area Network (MAN), Wide Area Network (WAN), 4G/5G network, WIFI, Bluetooth and Peer-To-Peer (P2P) communication network. The terminal device 4 can be a touch-control type mobile phone, a smart phone, a tablet computer, a computer, a portable terminal device or other terminal electronic device with a display screen.

In the present embodiment of the application, the image pick-up apparatus 1 and the terminal device 4 may each include one or more processors, which may be a central processing unit (CPU), or an Application Specific Integrated Circuit (ASIC), or one or more integrated circuits configured to implement the present embodiment, without being limited thereto. One or more processors included in the terminal device 4 may be the same type of processor, such as one or more CPU. It may also be a different type of processor, such as one or more CPU and one or more ASICs, and is not limited thereto.

The image pick-up apparatus 1 is installed in an area to be monitored (e. g., home, office, mall, field, crossroad, etc.), so that the image pick-up apparatus 1 can take monitoring video in the monitored area. After capturing a monitoring video, the image pick-up apparatus 1 can extract a video image as an image to be recognized by frame extraction or frame by frame, and upload the image to be recognized to the cloud server 2 via the network 3. After the cloud server 2 recognizes the image to be recognized, an image recognition result is sent to the terminal device 4 via the network 3 for a user to browse.

In some application scenarios where the image pick-up apparatus 1 has an image recognition function. After the image pick-up apparatus 1 captures an image to be recognized, the image to be recognized is directly recognized, then the image recognition result is sent to the terminal device 4 via the network 3 for the user to browse, and the image recognition result is sent to and stored in the cloud server 2 via the network 3.

In an embodiment of the present application, the image to be recognized is recognized by an image recognition model including an encoder and a detection head, so as to obtain an image recognition result of the image to be recognized. It can be understood that before the image recognition model is used to recognize the image to be recognized, the image recognition model is required to be trained so that the trained image recognition model can be used to recognize the image to be recognized. Based on this, a training method for an encoder provided by an embodiment of the present application will first be described herein. It should be noted that the present application relates only to training of the encoder, and that the detection heads can be trained ones, or can be trained by using prior art solutions.

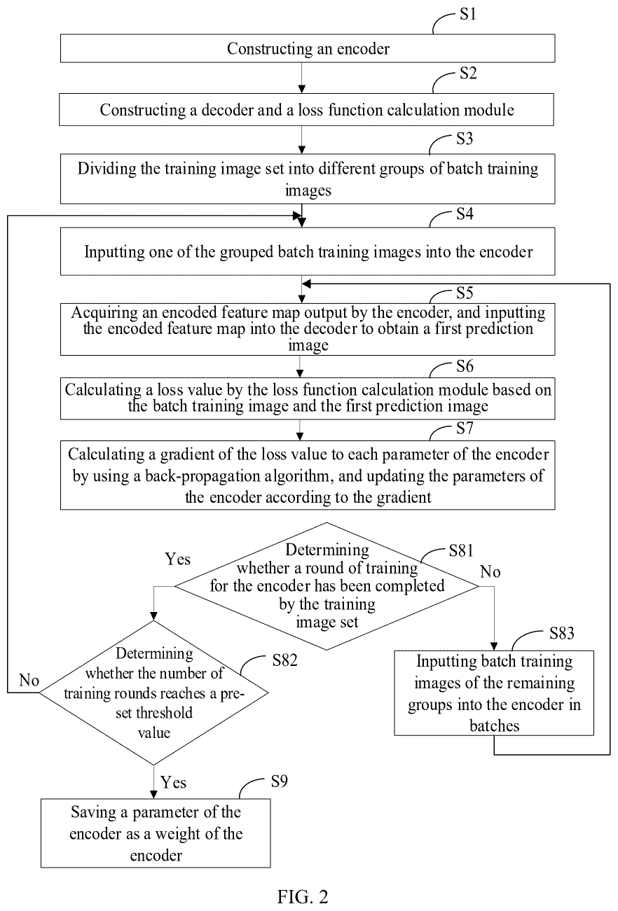

FIG. 2 shows a flow diagram of a training method for an encoder according to an embodiment of the present application. The training method for the encoder can complete the construction and training of the encoder by a local off-line electronic device (for example, an off-line computer device), and load the trained encoder and the detection head into the AI chip of the image pick-up apparatus 1 or the cloud server 2.

The electronic device may be an electronic device including one or more processors, which may be a central processing unit CPU, or an Application Specific Integrated Circuit (ASIC), or one or more integrated circuits configured to implement embodiments of the present invention, and is not limited thereto. The electronic device includes one or more processors, which may be the same type of processor, such as one or more CPU. It may also be a different type of processor, such as one or more CPU and one or more ASICs, and is not limited thereto.

Step S1: constructing an encoder. Herein, the encoder includes a first convolution layer, a plurality of second convolution layers connected in cascade, a first feature fusion layer and a second feature fusion layer. The first convolution layer is connected to the second convolution layer. The second convolution layer is connected to the first feature fusion layer. The first fusion layer is connected to the second fusion layer, and the second feature fusion layer is connected to the decoder. The convolution kernel size and the step size of the first convolution layer are the same.

The encoder is used for learning texture, shape, color and other features of an image, and extracting the image as a feature vector. In an embodiment of the present application, the encoder may be built on the basis of a YOLO v8 network. In particular, the first convolution layer of the YOLO v8 network is modified. Both the convolution kernel size and the step size are modified to the same value. The YOLO v8 detection header is deleted. The backbone network and the Neck layer for enhanced features are preserved. In addition, the original three outputs (P3, P4 and P5) in the YOLO v8 network are changed into a single output (P53), and only the output of the minimum feature map is retained, thus simplifying the convolution network structure of the encoder, enabling the feature map output by the constructed encoder to integrate multi-level features, and enhancing the learning ability of the encoder for different scale features. In an embodiment of the present application, by constructing an encoder based on the YOLO v8 backbone network, the encoder can be enabled to fuse the features of a multi-level feature map, and can focus on fine-grained features, thereby enhancing the robustness of the encoder features. At the same time, the encoder is constructed according to the YOLO v8 backbone network, and the encoder after training is suitable for target detection tasks, taking into account the accuracy, speed and memory, and can be deployed to the edge devices friendly.

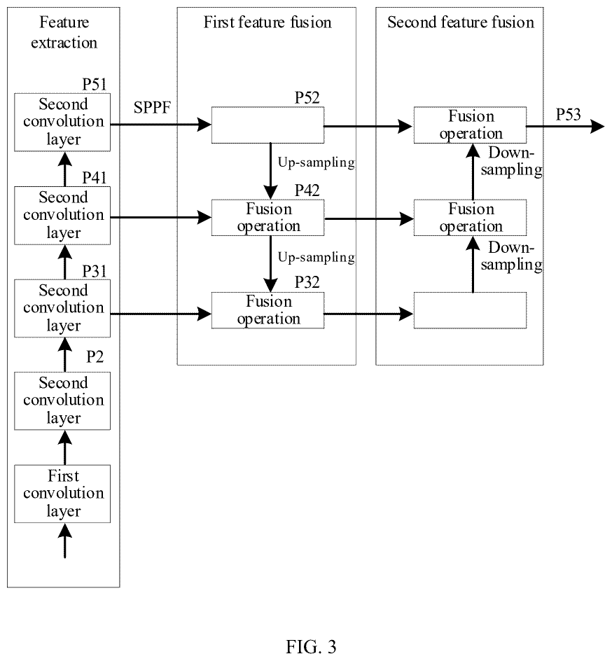

In order to better describe the encoder herein, FIG. 3 shows a structurally schematic diagram of an encoder according to an embodiment of the present application. As shown in FIG. 3, the encoder includes a first convolution layer for performing feature extraction and a cascade of five second convolution layers, and further includes a first feature fusion layer for performing a first feature fusion process and a second feature fusion layer for performing a second feature fusion process.

Herein, the convolution kernel size and the step size of the first convolution layer in an encoder are the same, and can be set according to needs. After an image input into the encoder passes through the first convolution layer, a first feature map output by the first convolution layer includes m feature image blocks, and m is related to the convolution kernel size and the step size of the first convolution layer. The size of m is related to a training task (such as a target detection task and a classification task), and different training tasks m are different. Therefore, after m is determined based on the training task, the convolution kernel size and the step size of the first convolution layer can be determined. For example, the convolution kernel size and the step size of the first convolution layer may both be set to 4, where m is a positive integer. The convolution kernel size and the step size of the second convolution layer may also be set as desired, e. g., the convolution kernel size of the second convolution layer may be set to 3 and the step size to 2.

In this step, by setting the convolution kernel size of the first convolution layer to be the same as the step size, and subsequently using the training image to train the encoder, the information exchange between different image blocks in the training image can be prevented, and the quality of the self-supervision task can be reduced.

Herein, the feature map of the convolution layer input has a width wᵢₙ and a height hᵢₙ. The feature map of the convolution layer output has a width wₒᵤₜ and a height hₒᵤₜ. The scale of the feature map of the input convolution layer and the scale of the feature map of the output of the convolution layer have the following relationships:

$${w}_{out} = \frac{⌊ {w}_{i n} + 2 p - k ⌋}{s} + 1 \qquad ( 1 )$$

$${h}_{o u t} = \frac{⌊ {h}_{i n} + 2 p - k ⌋}{s} + 1 \qquad ( 2 )$$

where p is the fill pixel size; k is the convolution kernel size of the convolution layer, s is the step size of the convolution layer; and the symbol └⋅┘ represents a round down function.

Step S2: constructing a decoder and a loss function calculation module; wherein a second feature fusion layer is connected to the decoder.

Since the encoder in the embodiment of the present application is a convolution network, a convolution decoder or other decoders can be constructed in the embodiment of the present application. A person skilled in the art can construct a decoder according to the prior art, and the specific way of constructing a decoder will not be described in detail here. It should be noted that, in order for the decoder to make full use of the global features of the encoded feature map output by the encoder, the decoder can be constructed according to the scales of the encoded feature map output by the encoder so that the decoder matches the scales of the encoded feature map.

When a training image is used to train an encoder, the encoder will output a prediction image, and a loss function calculation module is used for calculating a pixel loss value of each pixel point between the prediction image and the training image, so as to subsequently optimize the parameters of the encoder according to the loss value. Specifically, if the training image and the prediction image both include n pixel points, the prediction pixel value of the i^{th} pixel point in the prediction image is Ŷᵢ, and the actual pixel value of the i^{th} pixel point in the corresponding training image is Yᵢ, the loss function calculation module calculates the loss value by the following formula:

$$L = \frac{1}{n} {\sum }_{i = 1}^{n} {( {Y}_{i} - {\hat{Y}}_{i} )}^{2} \qquad ( 3 )$$

Step S3, dividing the training image set into different groups of batch training images. Herein, the batch training images of each group include a plurality of different training images.

The training image set is a pre-constructed image set, and can be an image set constructed by using an existing training image set or self-collecting and organizing, and can also be a set of an existing training image set and a self-collecting and organizing image set. The training image set includes a plurality of training images with different contents. The batch training image refers to the image used to perform the training of this batch. For example, if 1000 numbers of training images are included in the training image set, and the number of batch images is 50, the 1000 numbers of training images are divided into 20 groups of different batch training images in this step, and each group of batch training images includes 50 numbers of training images. After dividing the training image set into different groups of batch training images, the batch training images of each group can be pre-processed first. For example, the batch training images are processed by random horizontal inversion, random clipping, scaling, normalization, etc. so as to subsequently use the pre-processed batch training images to train the encoder, thereby improving the training effect of the encoder.

Step S4, inputting one of the grouped batch training images into the encoder.

Herein, one of the grouped batch training images is input to an encoder for training the encoder with the batch training images.

Step S5, acquiring an encoded feature map output by the encoder, and inputting the encoded feature map into the decoder to obtain a first prediction image.

Since the batch training images includes a plurality of training images, a first prediction image corresponding to each training image is correspondingly obtained in this step.

Step S6, calculating a loss value by the loss function calculation module based on the batch training image and the first prediction image.

Herein, the loss value can be determined according to the prediction pixel value of each pixel point in the first prediction image and the actual pixel value of the pixel point of the corresponding training image.

Step S7, calculating a gradient of the loss value to each parameter of the encoder by using a back-propagation algorithm, and updating the parameters of the encoder according to the gradient.

Step S81, determining whether a round of training for the encoder has been completed by the training image set. If yes, it goes to Step S82; and if not, the process proceeds to Step S83.

Herein, for example, 1000 training images are included in the training image set, these 1000 training images are completely traversed once for training the encoder, and then one training turn is completed. If the number of batch images is 50, 20 (1000/50) batches of training will be required to complete one training round.

Step S82, determining whether the number of training rounds reaches a preset threshold value. If yes, it goes to step S9; if not, the process proceeds to Step S4.

In order to ensure the accuracy of the obtained trained encoder, it is usually necessary to perform iterative training for a plurality of rounds on the encoder, and end the training after reaching a preset training round (setting a preset threshold value). The preset threshold may be set as needed, e. g., 100 times, 200 times, or 300 times, etc.

Step S83, inputting batch training images of the remaining groups into the encoder in batches.

Step S9, saving a parameter of the encoder as a weight of the encoder.

After the training is finished, the parameters of the encoder are saved as the weights of the encoder, so as to obtain a trained encoder.

In general, most encoder networks are designed for classification tasks, which lack of attention to the fine-grained features. When the decoder predicts an image, the resulting predicted image lacks the fine-grained features such as texture. However, the encoder in the embodiment of the present application is set on the basis of YOLO v8, and the network contains SPPF and Feature Pyramid Network (FPN) structures to fuse feature information of different scales. The fused large-scale feature map can capture more local and more detailed features, which is suitable for detecting fine-grained features and enhances the robustness of the encoder features, so that the training accuracy of the image recognition model is improved, and then the image can be accurately recognized by using the image recognition model including the trained encoder and the detection head.

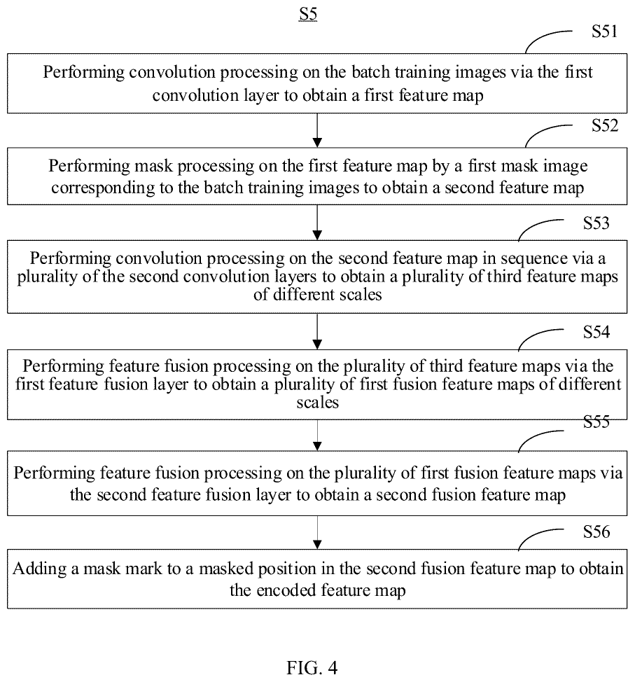

FIG. 4 shows a flow diagram of steps performed by the encoder in training the encoder according to an embodiment of the present application. As shown in FIG. 4, the encoder performs the steps of in the process of training the encoder.

Step S51, performing convolution processing on the batch training images via the first convolution layer to obtain a first feature map.

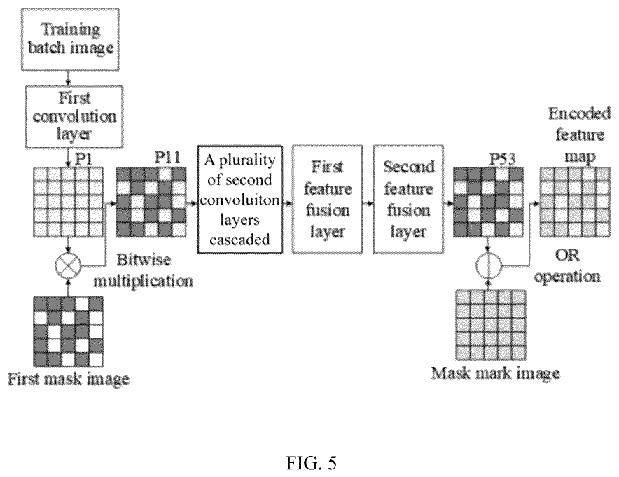

In order to better describe the feature maps involved in the various stages in the training of the encoder, FIG. 5 shows a schematic diagram of a feature map at various stages in the training of the encoder according to an embodiment of the present application. As shown in FIG. 5, after a batch of training images is input into an encoder, a first convolution layer in the encoder performs convolution processing on the batch of training images to obtain a first feature map P1. It is worth mentioning that a batch training images includes a plurality of images, a plurality of first feature maps are obtained correspondingly in this step, and the batch training images corresponds to the plurality of first feature maps on a one-to-one basis. Subsequent operations on the plurality of first feature maps are all the same. In order to facilitate the introduction, the embodiment of the present application only takes one of the first feature maps as an example for introduction.

As described above, after the batch training image is processed by a first convolution layer in an encoder, a first feature map P1 output by the first convolution layer includes m feature image blocks. In FIG. 4, only the first feature map including 25 (5×5) feature image blocks is described as an example.

Step S52, performing mask processing on the first feature map by a first mask image corresponding to the batch training images to obtain a second feature map.

The mask processing specifically refers to masking a part of pixel points in a first feature map, and the pixel value of the masked pixel points in the obtained second feature map is 0. The pixel value of the unmasked pixel points remains unchanged. The dimensions of the first mask image may or may not be the same as the dimensions of the first feature map. If the scale of the first mask image is smaller than the scale of the first feature map, and the first mask image includes k pixel points, the first mask image can only cover a part of the first feature map. The mask processing can only be performed on a part of the k pixel points in the first feature map and the positions covered by the first mask image, wherein k is a positive integer. If the scale of the first mask image is greater than or equal to the scale of the first feature map, the first mask image can cover the whole first feature map, and a part of pixel points in the whole first feature map can be masked. It should be noted that the same first mask image is used for the same batch training images and different first mask images are used for different batches of training images.

Step S53, performing convolution processing on the second feature map in sequence via a plurality of the second convolution layers to obtain a plurality of third feature maps of different scales.

As shown in FIG. 3, a plurality of third feature maps outputted by a plurality of second convolution layers are a feature map P31, a feature map P41, and a feature map P51, respectively.

Step S54, performing feature fusion processing on the plurality of third feature maps via the first feature fusion layer to obtain a plurality of first fusion feature maps of different scales.

As shown in FIG. 3, after a feature map P52 is obtained by processing the feature map P51 through a Spatial Pyramid Spatial Pyramid Pool Fast-implementation (SPPF) layer, the feature map P52 is upsampled to obtain a feature map with the same scale as that of the feature map P41, and a feature map P42 is obtained by fusing the feature map P52 with the feature map P41. The feature map P42 is upsampled to obtain a feature map with the same scale as that of the feature map P31, and then a feature map P32 is obtained by fusing the feature map P42 with the feature map P31. The feature map P52, the feature map P42 and the feature map P32 are a plurality of first fusion feature maps of different scales. It should be noted that the plurality of third feature maps in Steps S53 and S54 refer only to a feature map P31, a feature map P41 and a feature map P51, and do not include a feature map P2 output by the first one of the second convolution layer.

The merging operation can be implemented by the concat and Cross Stage Partial (CSP) layers in the YOLO v8 network.

Step S55, performing feature fusion processing on the plurality of first fusion feature maps via the second feature fusion layer to obtain a second fusion feature map.

As shown in FIG. 3, the feature map P32, the feature map P42, and the feature map P52 are fused to obtain a second fusion feature map P53. The specific process of the fusion operation is similar to that of Step S54, with the difference that Step S54 uses an up-sampling operation for the feature map before fusion, and Step S55 uses a down-sampling operation for the feature map before fusion.

Step S56, adding a mask mark to a masked position in the second fusion feature map to obtain the encoded feature map.

When the encoder is trained, the encoder is responsible for learning the features of the visible image block (the image block which is not masked), and the pixel value of the masked pixel point in the second fusion feature map P53 is 0, which cannot be directly input into the decoder. Therefore, in this step, a mask mark is firstly added to the masked position in the second fusion feature map P53 to supplement the information about the masked position, so that the obtained encoded feature map includes the information about the masked position. Meanwhile, after adding the mask mark, the mask mark can separate the information of the visible image block and the masked image block, and prevent the masked image block gradient from back-propagating to the encoder that learns the visible image block, thus improving the accuracy of the encoder after training. Also, the addition of mask marks as a learnable parameter to the output of the encoder rather than to the input can further reduce the total number of parameters of the network, because the resolution of the encoder output feature map is typically input 1/32.

If the convolution kernel size and the step size of the first convolution layer in the encoder are not the same, the information of the first feature map output by the first convolution layer will be overlapped, and then the information of the feature map covered by the mask in the obtained second feature map will be leaked, thus reducing the training effect. In the embodiment of the present application, by setting the convolution kernel size and the step size of the first convolution layer to be the same, the information of the first feature map output by the first convolution layer does not overlap, so that the above-mentioned situation can be effectively avoided, thereby improving the training effect and improving the accuracy of the trained encoder.

In some embodiments, in order to improve the training efficiency of the model, the encoder further includes layer LayerNorm, i. e., changing BatchNorm in the YOLO v8 network to layer normalization. Specifically, after performing normalization processing on the first feature map output by the first convolution layer through layer normalization, the mask processing is performed on the normalized first feature map and the corresponding first mask image so as to obtain a second feature map. By setting layer normalization, the pixel values of each pixel point in the first feature map can be normalized, so as to improve the training efficiency. Meanwhile, since BatchNorm focuses more on statistical consistency across samples, and LayerNorm focuses on the consistency of features within a single sample, in the embodiment of the present application, by changing BatchNorm in the YOLO v8 network to LayerNorm, it is possible to improve the attention of a single image.

In order to quickly obtain the second feature map, in an embodiment of the present application, the Step S52 includes steps of:

Step a1: constructing a first mask image corresponding thereto for the batch training images, wherein the first mask image has the same scale as the first feature map, and the pixel value of some pixel points in the first mask image is 0, and the pixel value of the remaining pixel points is 1.

In order to facilitate the introduction, in the embodiment of the present application, the first feature map PI includes 25 (5×5) feature image blocks. The first mask image includes 25 (5×5) mask image blocks as an example, and the positions of the 25 feature image blocks and the 25 mask image blocks correspond to each other on a one-to-one basis as an example for introduction. As shown in FIG. 5, the scale of the first mask image is the same as that of the first feature map P1, and the position of dark grey in the first mask image represents the position where the pixel value is 0. Namely, the pixel values of the pixel points in the first, second, third and fifth mask image blocks in the first row in the first mask image are all 0. The pixel values of the pixel points in the fourth mask image block in the first row are all 1. The mask image blocks in the second, third, fourth and fifth rows are similar to those in the first row, and the description thereof will not be repeated here.

Herein, the number of pixel points with a pixel value of 0 in the first mask image can be set according to needs. For example, if there are T pixel points in the first mask image, the pixel values of 50%*T pixel points can be set as 0, or the pixel values of 60%*T pixel points can be set as 0, which is not limited herein.

Step a2, performing bitwise multiplication processing on the first feature map and the first mask image to obtain the second feature map.

Since the scale of the first feature map P1 is the same as that of the first mask image, i. e., the number of pixel points of the two is the same, and in the present step, bitwise multiplication processing is performed on the first feature map P1 and the first mask image, then the pixel value of a pixel point with a pixel value of 0 in the first mask image is multiplied by the pixel point corresponding to the first feature map P1, and the pixel value of the corresponding pixel point in the first feature map P1 becomes 0. After a pixel point with a pixel value of 1 in the first mask image is multiplied by a pixel point corresponding to the first feature map P1, the pixel value of the corresponding pixel point in the first feature map P1 remains unchanged, so as to obtain the second feature map P11. As shown in FIG. 5, the second feature map P11 correspondingly includes 25 (5×5) feature image blocks, and the pixel values of the pixel points in the first, second, third and fifth feature image blocks in the first row are all 0. The pixel value of the pixel point in the fourth feature image block in the first row is the same as the pixel value of the corresponding pixel point in the first feature map P1. The feature image blocks in the second, third, fourth and fifth rows in the second feature map P11 are similar to the first row, which will not be described in detail here.

In the embodiment of the present application, after the first mask image is constructed, the second feature map P11 can be obtained by using the first mask image and the first feature map P1 to perform bitwise multiplication processing, and the processing method is simple, thereby improving the efficiency of obtaining the second feature map. In addition, in the embodiment of the present application, by constructing the first mask image having the same scale as that of the first feature map P1, rather than the first mask image having a scale greater than or less than that of the first feature map P1, waste of resources can be avoided and the accuracy of the trained encoder can be improved.

In order to balance the training efficiency and accuracy of the encoder, in the embodiment of the present application, the pixel values of the a*T pixel points in the first mask image are 0, and the pixel values of the remaining pixel points are 1, wherein T is the total number of pixel points in the first mask image, 60%≤a≤75%. For example, a is 60%, 65%, 70% or 75%, the symbol “*” represents a multiplication sign.

It can be understood that if the greater the number of pixel points with a pixel value of 0 in the first mask image, the greater the number of pixel points with a pixel value of 0 in the obtained second feature map P11, i. e., the greater the number of masked feature image blocks in the obtained second feature map P11, then the fewer unmasked feature image blocks in the encoded feature map which are finally input to the decoder, which requires the decoder to learn the information in the fewer unmasked feature image blocks and predict the information of the more masked feature images, thereby increasing the difficulty of model training. In the embodiment of the present application, by setting the pixel values of 60%*T to 75%*T pixel points in the first mask image to be 0, neither too few and too many unmasked feature image blocks in the encoding feature map will be caused, so that the training efficiency and accuracy of the encoder can be well balanced, and the accuracy of the obtained trained encoder can be effectively ensured to meet application requirements without seriously reducing the training efficiency of the encoder.

In some embodiments, the training method for the encoder further includes: constructing a mask mark image, wherein the mask mark image and the second fusion feature map have the same scale; and Step S56 includes performing OR operation processing on the second fusion feature map and the mask mark image to obtain the encoded feature map.

Herein, the pixel value of each pixel point in the mask mark image can be initialized to 0, and the length is a learnable parameter of the decoder output length. As shown in FIG. 5, an OR operation process is performed on the mask mark image and the second fusion feature map P53, namely, an OR operation process is performed on each pixel point in the mask mark image and a corresponding pixel point in the second fusion feature map P53, so that a mask mark is added to an obscured position in the second fusion feature map P53 so as to obtain an encoded feature map. The encoded feature map has the same scale as the P53 of the second fusion feature map. In FIG. 5, the second fusion feature map P53 includes 25 (5×5) feature image blocks, and the encoded feature map correspondingly includes 25 (5×5) encoded feature image blocks. Taking the second fusion feature map P53 and the image block of the first row in the encoded feature map as an example, since the first, second, third and fifth feature image blocks in the first row in the second fusion feature map P53 are masked, the first, second, third and fifth feature image blocks in the first row in the corresponding encoded feature map are added with mask marks. It should be noted that only the case where the second fusion feature map P53 includes 25 (5×5) feature image blocks is illustrated in FIG. 5, in fact, the scale of the second fusion feature map P53 obtained after the second feature map P11 passes through the second convolution layer and the feature fusion layer is smaller than that of the second feature map P11.

In the embodiment of the present application, after a mask mark image is constructed, an encoded feature map can be obtained by performing OR operation processing on the second fusion feature map and the mask mark image, and the operation is simple, so that the encoded feature map can be obtained quickly, and the efficiency of training an encoder is improved.

In some embodiments, the inputting the encoded feature map into the decoder to obtain a first prediction image includes:

Step b1, performing stretching processing on the encoded feature map to obtain an encoded feature map represented by a one-dimensional vector; and

Step b2, inputting the encoded feature map represented by the one-dimensional vector into the decoder to obtain the first prediction image, wherein the decoder is a Transformer decoder.

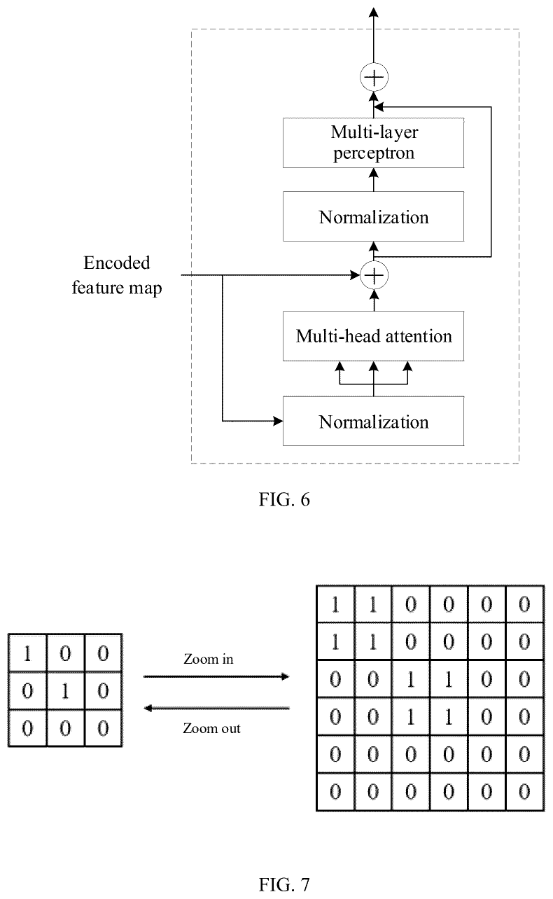

In order to better describe the Transformer decoder herein, FIG. 6 shows a structurally schematic diagram of a Transformer decoder according to an embodiment of the present application. As shown in FIG. 6, the decoder is a decoder constructed based on a single-layer Transformer network, and the single-layer Transformer network includes a layer normalization, a multi-head attention layer, and a multi-layer perceptron, etc. Since the decoder is a Transformer decoder, and based on the characteristics of the Transformer decoder, since only the feature map of the one-dimensional vector can be input into the Transformer decoder, in step b1, the encoded feature map is firstly stretched to obtain the encoded feature map of the one-dimensional vector so as to adapt to the input shape of the decoder.

It will be appreciated that stretching the encoded feature map merely changes the shape of the encoded feature map and does not lose the information in the encoded feature map, so that the encoded feature map of the resulting one-dimensional vector retains all of the information of the encoded feature map. That is to say, in the embodiment of the present application, by using a Transformer decoder, global information about an encoded feature map can be used to predict locally obscured information, and using only one layer of Transformer can reduce the complexity of the decoder, reduce feature learning, and improve the robustness of encoder features, so as to make the encoder applicable to more downstream tasks and improve the application scenario of the encoder.

In addition, in the field of natural language processing and MAE, the encoder network structure is Transformer network, which can pay attention to the global information of data and assign the attention weight of global information according to the self-attention mechanism. It is very suitable for self-supervised training tasks that need global information. However, the Transformer network is not as fast and memory efficient as the convolution network in the edge-end deployment. In the FCMAE method, the encoder uses convolution network, but its activation function GELU is unfriendly to the edge terminal deployment, and part of the edge terminal is not supported. In the embodiment of the present application, an encoder is constructed based on a YOLO v8 network. The network is a convolution network. The network is designed for a one-stage target detection task, is friendly to the deployment of edge-end devices, has a fast calculation speed and saves memory.

Meanwhile, in the embodiment of the present application, the encoded feature map fused with multi-scale feature map information in the convolutional encoder is input into the constructed Transformer decoder, so that the Transformer decoder can pay more attention to the fine-grained feature. Most of the encoder networks used in the prior art are designed for classification tasks, lack attention to fine-grained features. When the decoder predicts an image, the image lacks fine-grained features such as texture. The encoder in the embodiment of the present application is constructed based on YOLO v8, and the network contains SPPF and FPN structures, which can fuse the feature information of different scales and enhance the robustness of the encoder features. In addition, if a convolutional decoder is constructed, the convolutional decoder can only process the features output from the convolution kernel region at one time. However, in the embodiment of the present application, using a Transformer structure as a decoder of the convolutional encoder can process all the features output from the encoder at the same time, adjusting the importance of a global feature and a local feature at different positions according to an attention mechanism, so as to improve the flexibility of the decoder.

Further, the Transformer decoder in embodiments of the present application is more able to take advantage of global features. The decoder in the prior art uses a convolution network with a convolution kernel size of 7×7. In the case of an input image size of 224×224, the decoder input feature map size is 7×7, which is equal to the convolution kernel size, in which case the convolution kernel can utilize global features. When the size of the input image is larger than 224×224, the size of the input feature map of the decoder increases accordingly, the 7×7 convolution kernel can not cover the feature map, and only a relatively large local area feature can be used in decoding. Thus, the modeling ability of the target distance relationship within the image is not sufficient. However, in the embodiment of the present application, by constructing a Transformer decoder, a global feature in an encoded feature map can be used when predicting each pixel point. When the size of an input image is 640×640, the size of an input feature map of the decoder is 20×20, and then the self-attention mechanism of the Transformer decoder can better handle long-distance dependency relationships.

A first feature map obtained by performing convolution processing on a training image by a first convolution layer in an encoder includes a plurality of feature image blocks. In order to obtain a first prediction image, in the example of the present application, the first feature map includes a plurality of feature image blocks, and the inputting the encoded feature map into the decoder to obtain a first prediction image includes:

Step c1, inputting the encoded feature map into the decoder to obtain a plurality of prediction image blocks output by the decoder, wherein the plurality of feature image blocks correspond to the plurality of prediction image blocks one by one.

Herein, as stated above, the first feature map P1 obtained by the convolution processing of the training image by the first convolution layer in the encoder includes a plurality of feature image blocks. Therefore, the encoded feature map finally output by the encoder also includes a plurality of feature image blocks. When inputting a plurality of feature image blocks into a decoder, we correspondingly obtain a prediction image block corresponding to each feature image block output by the decoder.

It should be noted that the encoder of the embodiment of the present application is constructed based on the YOLO v8 network, and the partial convolution layer in the YOLO v8 encoder is provided with a 7×7 convolution kernel, the partial convolution layer is provided with a 2×2 convolution kernel, and the convolution layer of the 7×7 convolution kernel can simultaneously process a plurality of image blocks. For example, when an image is down-sampled to a size of 7×7 pixel points (where 1 pixel point represents one image block), the 7×7 convolution kernel can process all image blocks simultaneously and output all processed image blocks simultaneously.

Step c2, performing inverse blocking processing on the plurality of prediction image blocks to obtain the first prediction image.

Herein, the decoder will output all the prediction image blocks at a time. In this step, the first prediction image can be obtained by performing inverse blocking processing on all the prediction image blocks at the same time (namely, splicing image blocks into a whole image).

In an embodiment of the present application, by performing inverse blocking processing on a plurality of prediction image blocks, a complete first prediction image is obtained, so that a loss value can be subsequently calculated using the first prediction image and a corresponding training image, thereby improving the efficiency of subsequent calculation of the loss value.

In some embodiments, the training method for the encoder further includes the steps of:

Step d1, performing scaling processing on the first mask image to obtain a second mask image, wherein the scale of the second mask image is the same as that of the first prediction image.

After the first feature map P1 is processed by a plurality of second convolution layer cascaded, it may occur that the scale of the encoded feature map finally output by the encoder is different from that of the first feature map P1. The scale of the first prediction image is related to the scale of the encoded feature map, which is the same as the scale of the encoded feature map. In this step, if the scale of the first prediction image is different from that of the first mask image, the scaling process is performed on the first mask image so as to obtain a second mask image having the same scale as that of the first prediction image.

In particular, since the scale of the batch training image and the structure of the constructed encoder are known in advance, the scaling scale can be determined in advance, and is usually set to a multiple of 2, so as to ensure that the number of pixel points can be divided by the number of pixel points at the time of scaling, and no remainder occurs. If the first mask image is enlarged, the number of pixel points in the second mask image is greater than that in the first mask image, and the pixel values of the increased pixel points in the second mask image can be determined by nearest neighbor interpolation. If the first mask image is reduced, the number of pixel points in the second mask image is less than that in the first mask image. The pixel value of each pixel point in the second mask image can be determined by the bilinear interpolation method. Specifically, the pixel value of each pixel point in the second mask image is obtained by a weighted average of the pixel values of a plurality of pixel points in the first mask image.

Here, in order to better describe the first mask image and the second mask image, FIG. 7 shows a schematic diagram of pixel values of each pixel point in a first mask image and a second mask image according to an embodiment of the present application. As shown in FIG. 7, (a) of FIG. 7 includes pixel values of 9 pixel points, and (b) of FIG. 7 includes pixel values of 36 pixel points. If (a) is a first mask image, the magnification processing is performed thereon. If the magnification scale is 2 times, a second mask image in (b) can be obtained by the nearest neighbor interpolation method. If (b) is a first mask image, the reduction processing is performed on the first mask image. When it is reduced to half of the original size, a second mask image in (a) is obtained by means of bilinear interpolation. In the embodiment of the present application, when the first mask image is reduced, by using the interpolation algorithm, the smoothness of the image can be maintained and the jaggy effect can be avoided.

Step d2, performing inverse processing on pixel values of various pixel points in the second mask image to obtain a third mask image.

In this step, the inverse processing is performed on the pixel value of each pixel point in the second mask image, which specifically refers to changing the pixel value of the pixel point with the pixel value being 0 in the second mask image to 1, and changing the pixel value of the pixel point with the pixel value being 1 to 0.

After inputting the encoded feature map into a decoder to obtain a first prediction image, the training method for the encoder further includes performing the bitwise multiplication processing on the first predicted image and the third mask image to obtain a second predicted image.

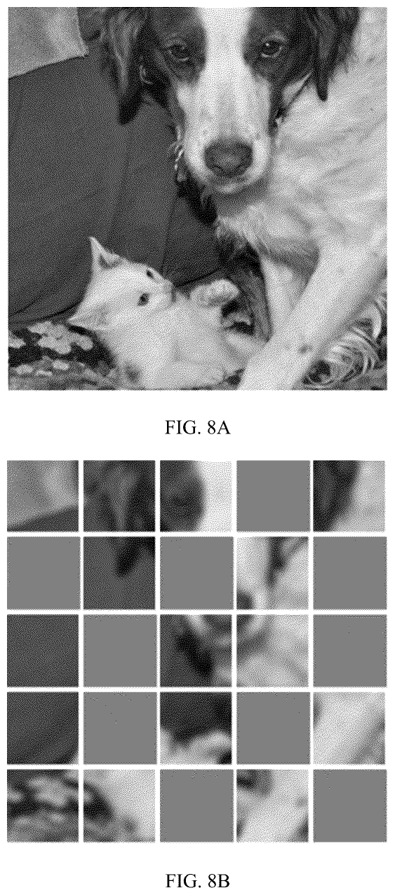

In order to better describe the training image and the second prediction image herein, FIG. 8A and FIG. 8B show schematic diagrams of a training image and a corresponding second prediction image according to an embodiment of the present application. As shown in FIG. 8A is a training image, and FIG. 8B is a second prediction image. With reference to FIG. 5, after performing the bitwise multiplication processing on the first feature map P1 and the first mask image, part of the feature image blocks in the obtained second feature map P11 are masked, and the rest of the feature image blocks are not masked. Taking the second feature map P11 and the image block in the first row in the second prediction image as an example, the first, second, third and fifth image blocks in the second feature map P11 are masked. That is to say, the information about a position where a decoder predicts the masking is required, the first, second, third and fifth image blocks in the corresponding second prediction image include prediction information output by the decoder. Since the fourth image block in the second feature map P11 is not masked, that is to say, the fourth image block is a visible image block for the decoder, the information about the fourth image block predicted by the decoder is unnecessary. Thus, the fourth image block in the second predicted image is masked by this step so that the pixel values of the fourth image block are ignored when the loss value is subsequently calculated using the second predicted image.

The Step S6 includes inputting the batch training image and the second prediction image into the loss function calculation module to obtain a loss value output by the loss function calculation module.

In this step, the loss of all positions of the second prediction image and the training image can be calculated first, and the loss function formula is as shown in Formula (3). The corresponding loss is taken out according to the masked position (namely, the position where the value pixel value is 0) in the first mask image. Finally, the loss value of the second prediction image is obtained by averaging the losses of this part. At this time (3), n is the pixel number of the pixel point in the visible image block (the image block which is not masked) in the second prediction image. Ŷᵢ is the pixel value of the i^{th} visible pixel point in the second prediction image. Yᵢ is the actual pixel value of the i^{th} visible pixel point in the corresponding training image.

For an unmasked (visible) image block in a training image. Since when it is input into a model to train the model, the model sees this part of the image block, it is also simpler to predict this part of the image block, and accordingly this part of the loss belongs to an invalid loss A. For the masked image block in the training image, since the model fails to see this part of the image block, the loss of the image block at the corresponding position in the obtained prediction image is larger than that in the training image, and this part of the loss belongs to the effective loss B. The final loss value is (A+B)/2. It is known by the formula that the effective loss of the final loss becomes smaller, which will lead to the reduction of model training efficiency.

Therefore, in view of the above-mentioned situation, in the embodiment of the present application, since the obtained second prediction image is masked by the image block which has been seen by the model, and only the prediction information corresponding to the image block which has not been seen by the model is retained. When the loss value is calculated according to the formula (3), only the effective loss is calculated, and there is no invalid loss, thereby improving the training efficiency of the model.

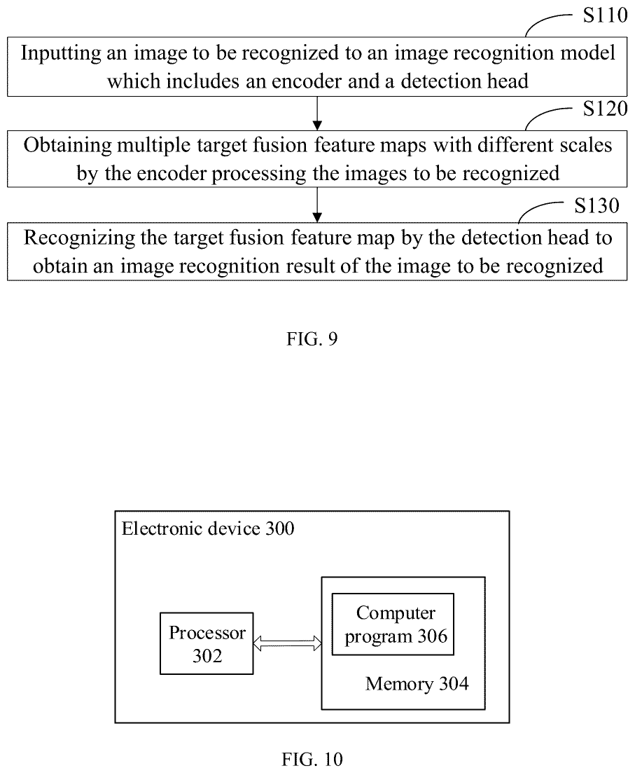

FIG. 9 shows a flow diagram of an image recognition method according to an embodiment of the present application. As shown in FIG. 9, the image recognition method includes the steps of:

Step S110, inputting an image to be recognized to an image recognition model which includes an encoder and a detection head.

The detection head (detection head) is the same as that in the YOLO v8. The detection head in the YOLO v8 is prior art. Therefore the structure, principle and implementation of the detection head will not be described in detail here.

Step S120, obtaining multiple target fusion feature maps with different scales by the encoder processing the images to be recognized.

Step S130, recognizing the target fusion feature map by the detection head to obtain an image recognition result of the image to be recognized. Herein, the encoder is an encoder obtained by any of the above-mentioned embodiments of the training method for the encoder. In the embodiment of the present application, the image recognition result may be simultaneously output to the terminal device 4 or directly displayed on the display screen of the terminal device 4.

It should be noted that the image recognition method provided by the embodiments of the present application can be applied to an image pick-up apparatus or a terminal device. It is only necessary to deploy a trained encoder and a detection head together on the applied device.

FIG. 10 shows a schematic structural diagram of an electronic device provided by an embodiment of the present application, and the specific embodiment of the present application does not limit the specific implementation of the electronic device.

As shown in FIG. 10, the electronic device 300 may include a processor 302 and a memory 304.

Herein, the memory 304 is configured for storing a computer program 306. The volatile memory 304 may include a high-speed RAM memory, but may also include a non-volatile memory, such as at least one disk memory. The computer program 306 may include computer-executable instructions.

The processor 302 is configured for executing a computer program 306 to implement the training method embodiments of the encoder described above, and/or the image recognition method embodiments described above. In an embodiment of the present application, the encoder training method may be performed by an electronic device 300 (for example, an off-line computer device) to complete the construction and training of an encoder, and load the trained encoder and a detection head into an image pick-up apparatus 1 or a cloud server 2. Therefore, when the training method for the encoder is executed, the electronic device 300 can be the image pick-up apparatus 1 or the cloud server 2 in FIG. 1. When the image recognition method is executed, the electronic device 300 can be the image pick-up apparatus 1 or the cloud server 2 in FIG. 1, and can also be other devices with an encoder and a detection head deployed.

The processor 302 may be a central processing unit CPU, or an Application Specific Integrated Circuit (ASIC), or one or more integrated circuits configured for implementing embodiments of the present application. The electronic device 300 includes one or more processors, which may be the same type of processor, such as one or more CPU. It may also be a different type of processor, such as one or more CPUs and one or more ASICs.

Embodiments of the present application provide a computer-readable storage medium storing a computer program which, when executed by a processor, implements the training method embodiments of the encoder described above, and/or the image recognition method embodiments described above.

Embodiments of the present application provide a computer program executable by a processor to implement the training method embodiments of the encoder described above, and/or the image recognition method embodiments described above.

Embodiments of the present application provide a computer program product including a computer program which, when executed by a processor, implements the training method embodiments of the encoder described above and/or the image recognition method embodiments described above.

In several embodiments provided herein, any of the functions, if implemented in the form of software functional modules/units and sold or used as a stand-alone product, may be stored in a computer-readable storage medium. It will thus be appreciated that all or part of the technical aspects of the present application may be embodied in the form of a software product stored on a storage medium including instructions for causing a computer device (which may be a personal computer, a server or the like) to perform all or part of the steps of a method as described in the various embodiments of the present application. Moreover, the above-mentioned storage medium includes various media, such as a USB disk, a removable hard disk, a Read-Only Memory (ROM), a Random Access Memory (RAM), magnetic or optical disks, which can store computer program code.

The algorithms or displays presented herein are not inherently related to any particular computer, virtual system, or other apparatus. Various general-purpose systems may also be used with the teachings based herein. The structure required to construct such a system will be apparent from the above description. In addition, embodiments of the present application are also not directed to any particular programming language. It will be appreciated that a variety of programming languages may be used to implement the teachings of the present application as described herein, and the above description of specific languages is provided to disclose the best mode of performing the present application.

It should be noted that the above-mentioned embodiments illustrate rather than limit the present application, and that those skilled in the art will be able to design alternative embodiments without departing from the scope of the appended claims. In the claims, any reference signs placed between parentheses shall not be construed as limiting the claim. The word “including” does not exclude the presence of elements or steps other than those listed in a claim. The word “a” or “an” preceding an element does not exclude the presence of a plurality of such elements. The application can be implemented by means of hardware including several distinct elements, and by means of a suitably programmed computer. In the claims enumerating several means, several of these means can be embodied by one and the same item of hardware. The use of the words first, second, third, and the like does not denote any order. These words may be interpreted as names. The steps in the above-described embodiments, unless otherwise specified, should not be construed as limiting the order of execution.

The embodiments described above represent only a few implementations of the present application and are described in more detail, but are not to be construed as limiting the scope of the claims of the present application. It should be noted that several variations and modifications can be made by one skilled in the art without departing from the inventive concept of the present application, which is within the scope of the present application. Therefore, the protection scope of the present application is as set forth in the claims below.

What is claimed is:

1. An image recognition method, comprising:
inputting an image to be recognized into an image recognition model comprising an encoder and a detection head;
processing the image to be recognized by the encoder to obtain a plurality of target fusion feature maps with different scales; and
recognizing the target fusion feature map by the detection head to obtain an image recognition result of the image to be recognized.

2. The image recognition method according to claim 1, wherein the encoder is trained by performing operations comprising:
constructing an encoder to be trained;
constructing a decoder and a loss function calculation module;
dividing a training image set into different groups of batch training images;
inputting one of the grouped batch training images into the encoder;
acquiring an encoded feature map and inputting the encoded feature map into the decoder to obtain a first prediction image;
calculating a loss value by the loss function calculation module based on the batch training image and the first prediction image;
calculating a gradient of the loss value to each parameter of the encoder by using a back-propagation algorithm, and updating the parameters of the encoder according to the gradient;
inputting batch training images of the remaining groups into the encoder in batches to update the parameters of the encoder until one round of training of the encoder is completed by the training image set; and
saving the updated parameters of the encoder as weights of the encoder when the number of training rounds reaches a preset threshold value.

3. The image recognition method according to claim 2, wherein the encoder comprises a first convolution layer, a plurality of second convolution layers connected in cascade, a first feature fusion layer and a second feature fusion layer, wherein the first convolution layer is connected to the second convolution layer; the second convolution layer is connected to the first feature fusion layer; the first fusion layer is connected to the second fusion layer, wherein the convolution kernel size and the step size of the first convolution layer are the same; and the second feature fusion layer is connected to the decoder.

4. The image recognition method according to claim 3, wherein the encoded feature map is output from the encoder by performing operations comprising:
performing convolution processing on the batch training images via the first convolution layer to obtain a first feature map;
performing mask processing on the first feature map by a first mask image corresponding to the batch training images to obtain a second feature map;
performing convolution processing on the second feature map in sequence via a plurality of the second convolution layers to obtain a plurality of third feature maps of different scales;
performing feature fusion processing on the plurality of third feature maps via the first feature fusion layer to obtain a plurality of first fusion feature maps of different scales;
performing feature fusion processing on the plurality of first fusion feature maps via the second feature fusion layer to obtain a second fusion feature map; and
adding a mask mark to a masked position in the second fusion feature map to obtain the encoded feature map.

5. The image recognition method according to claim 4, wherein the second feature map is obtained by performing operations comprising:
constructing a first mask image corresponding thereto for the batch training images, wherein the first mask image has the same scale as the first feature map, and the pixel value of some pixel points in the first mask image is 0, and the pixel value of the remaining pixel points is 1; and
performing bitwise multiplication processing on the first feature map and the first mask image to obtain the second feature map.

6. The image recognition method according to claim 5, wherein pixel values of a*T pixel points in the first mask image are 0, and the pixel values of the remaining pixel points are 1, wherein T is the total number of pixel points in the first mask image, 60%≤a≤75%, and the symbol “*” represents a multiplication sign.

7. The image recognition method according to claim 4, wherein the encoder is further trained by performing operations comprising:
constructing a mask mark image, wherein the mask mark image and the second fusion feature map have the same scale; and
performing OR operation processing on the second fusion feature map and the mask mark image to obtain the encoded feature map.

8. The image recognition method according to claim 2, wherein the first prediction image is obtained by performing operations comprising:
performing stretching processing on the encoded feature map to obtain the encoded feature map represented by a one-dimensional vector; and
inputting the encoded feature map represented by the one-dimensional vector into the decoder to obtain the first prediction image, wherein the decoder is a Transformer decoder.

9. The image recognition method according to claim 4, wherein the inputting the encoded feature map into the decoder to obtain a first prediction image comprises:
inputting the encoded feature map into the decoder to obtain a plurality of prediction image blocks output by the decoder, wherein a plurality of feature image blocks of the first feature map correspond to the plurality of prediction image blocks one by one; and
performing inverse blocking processing on the plurality of prediction image blocks to obtain the first prediction image.

10. The image recognition method according to claim 4, wherein the encoder is further trained by preforming operations comprising:
performing scaling processing on the first mask image to obtain a second mask image, wherein the scale of the second mask image is the same as that of the first prediction image;
performing inverse processing on pixel values of various pixel points in the second mask image to obtain a third mask image;
performing bitwise multiplication processing on the first prediction image and the third mask image to obtain a second prediction image; and
inputting the batch training image and the second prediction image into the loss function calculation module to obtain a loss value output by the loss function calculation module.

11. The image recognition method according to claim 4, wherein the first feature map comprises a plurality of feature image blocks; the first mask image comprises a plurality of mask image blocks; and the plurality of feature image blocks and the plurality of mask image blocks are the same in number and have one-to-one correspondence in position.

12. An electronic device, comprising a memory, at least one processor and a computer program stored on the memory, wherein the at least one processor executes the computer program to perform operations comprising:
inputting an image to be recognized into an image recognition model comprising an encoder and a detection head;
processing the image to be recognized by the encoder to obtain a plurality of target fusion feature maps with different scales; and
recognizing the target fusion feature map by the detection head to obtain an image recognition result of the image to be recognized.

13. The electronic device according to claim 12, wherein the encoder is trained by performing operations comprising:
constructing an encoder to be trained;
constructing a decoder and a loss function calculation module;
dividing a training image set into different groups of batch training images;
inputting one of the grouped batch training images into the encoder;
acquiring an encoded feature map and inputting the encoded feature map into the decoder to obtain a first prediction image;
calculating a loss value by the loss function calculation module based on the batch training image and the first prediction image;
calculating a gradient of the loss value to each parameter of the encoder by using a back-propagation algorithm, and updating the parameters of the encoder according to the gradient;
inputting batch training images of the remaining groups into the encoder in batches to update the parameters of the encoder until one round of training of the encoder is completed by the training image set; and
saving the updated parameters of the encoder as weights of the encoder when the number of training rounds reaches a preset threshold value.

14. The electronic device according to claim 13, wherein the encoder comprises a first convolution layer, a plurality of second convolution layers connected in cascade, a first feature fusion layer and a second feature fusion layer, wherein the first convolution layer is connected to the second convolution layer; the second convolution layer is connected to the first feature fusion layer; the first fusion layer is connected to the second fusion layer, wherein the convolution kernel size and the step size of the first convolution layer are the same; and the second feature fusion layer is connected to the decoder.

15. The electronic device according to claim 14, wherein the encoded feature map is output from the encoder by performing operations comprising:
performing convolution processing on the batch training images via the first convolution layer to obtain a first feature map;
performing mask processing on the first feature map by a first mask image corresponding to the batch training images to obtain a second feature map;
performing convolution processing on the second feature map in sequence via a plurality of the second convolution layers to obtain a plurality of third feature maps of different scales;
performing feature fusion processing on the plurality of third feature maps via the first feature fusion layer to obtain a plurality of first fusion feature maps of different scales;
performing feature fusion processing on the plurality of first fusion feature maps via the second feature fusion layer to obtain a second fusion feature map; and
adding a mask mark to a masked position in the second fusion feature map to obtain the encoded feature map.

16. The electronic device according to claim 15, wherein the encoder is further trained by performing operations comprising:
constructing a mask mark image, wherein the mask mark image and the second fusion feature map have the same scale; and
performing OR operation processing on the second fusion feature map and the mask mark image to obtain the encoded feature map.

17. The electronic device according to claim 13, wherein the first prediction image is obtained by preforming operations comprising:
performing stretching processing on the encoded feature map to obtain the encoded feature map represented by a one-dimensional vector; and
inputting the encoded feature map represented by the one-dimensional vector into the decoder to obtain the first prediction image, wherein the decoder is a Transformer decoder.

18. The electronic device according to claim 15, wherein the encoder is further trained by preforming operations comprising:
performing scaling processing on the first mask image to obtain a second mask image, wherein the scale of the second mask image is the same as that of the first prediction image;
performing inverse processing on pixel values of various pixel points in the second mask image to obtain a third mask image;
performing bitwise multiplication processing on the first prediction image and the third mask image to obtain a second prediction image; and
inputting the batch training image and the second prediction image into the loss function calculation module to obtain a loss value output by the loss function calculation module.

19. The electronic device according to claim 15, wherein the first feature map comprises a plurality of feature image blocks; the first mask image comprises a plurality of mask image blocks; and the plurality of feature image blocks and the plurality of mask image blocks are the same in number and have one-to-one correspondence in position.

20. A non-transitory computer-readable storage medium having a plurality of computerized program instructions stored thereon, when executed by one or more processors, cause the one or more processors to performing operations comprising:
inputting an image to be recognized into an image recognition model comprising an encoder and a detection head;
processing the image to be recognized by the encoder to obtain a plurality of target fusion feature maps with different scales; and
recognizing the target fusion feature map by the detection head to obtain an image recognition result of the image to be recognized.
